(19) United States
(12) Patent Application Publication
(10) Pub. No.: US 2016/0078449 A1
(43) Pub. Date: Mar. 17, 2016

(54) Two-Way Interactive Support

(71) Applicant: Bank of America Corporation, Charlotte, NC (US)

(72) Inventor: Nirmalya Banerjee, Hyderabad (IN)

(21) Appl. No.: 14/483,385

(22) Filed: Sep. 11, 2014

(51) Int. Cl. G06Q 30/00; G06T 19/00; H04L 29/06

(52) U.S. Cl. CPC G06Q 30/016; H04L 65/4084; H04L 65/1069; G06T 19/006

(57) ABSTRACT

Systems, methods and apparatuses providing two-way interactive customer service support. In some examples, a user may request customer service via an augmented reality device. The augmented reality device may include a camera or other device configured to capture images of what the user is viewing. The images captured may be streamed to a computing device of a customer service associate assisting the user. The customer service associate may then move a cursor over the display of the video stream from the augmented reality device. The cursor movements may be indicative of actions the user may mimic on his or her own computing device in order to access functionality, resolve an issue, or the like. The coordinates of the cursor movement may be captured and transmitted to the augmented reality device. The cursor movement may then be replicated on a display of the augmented reality device based on the received coordinates.

### BACKGROUND

Customer service is an important aspect of many businesses. Accordingly, companies and other entities are often looking for ways to improve customer service. One potential area of improvement may include changing or improving the way a customer service agent interacts with the customer. For instance, customer service agents are often limited in the amount of information they may access, often cannot view exactly what the customer is viewing and so must rely on description by the customer, and the like. At the same time, customer service agents have a limited ability to communicate any information or instructions back to the customers. Often, communication back to the customer is restricted to only verbal communication or written communication, without the ability to use any visual aids, or the like. Accordingly, providing ways for the customer service agent to more closely interact or interface with the customer may improve the customer service experience.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems, and apparatuses for providing two-way interactive customer service support. In some examples, a user or customer may request customer service via, for example, an augmented reality device. The augmented reality device may include an optical, head-mounted display, such as augmented reality glasses. The augmented reality device may include a camera or other device configured to capture images of what the user or customer is viewing. For instance, the camera may capture images of, for instance, a computing device of the user or customer, an application with which the user or customer is requesting support, or the like. The images captured may be streamed to a computing device of a customer service agent or associate assisting the user or customer.

The customer service associate may then manipulate or move a cursor over the display of the video stream from the augmented reality device. The cursor movements may be indicative of actions the customer or user may mimic on his or her own computing device in order to access functionality, resolve an issue, or the like. Thus, the customer service associate may provide instructions to the user by moving a mouse to indicate one or more selections on the computing device of the customer service associate.

The coordinates of the cursor movement may be captured and transmitted to the augmented reality device. The cursor movement may then be replicated on a display of the augmented reality device based on the received coordinates. Accordingly, the user may view the cursor movements of the customer service associate on the display of the augmented reality device which may align with the computing device of the user such that the user or customer is instructed in how to proceed. As desired, the user may mimic the cursor movements of the customer service associate on the computing device via a mouse or other input device connected thereto.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example two-way interactive customer service system according to one or more aspects described herein.

FIG. 4 is an example method of associating or pairing an augmented reality device with a device or application (e.g., an online or mobile application) according to one or more aspects described herein.

FIG. 5 is an example method of receiving a request for customer service via the two-way interactive customer service system according to one or more aspects described herein.

FIG. 6 is an example method of requesting service via the two-way interactive customer service system according to one or more aspects described herein.

FIGS. 7A-7D illustrate various aspects of the two-way interactive customer service system according to one or more aspects described herein.

FIG. 8 illustrates an example two-way interactive customer service system with example communication links according to one or more aspects described herein.

FIG. 9 is a schematic illustration of various aspects of the two-way interactive customer service system according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

Aspects described herein relate to a two-way interactive support system for providing, for instance, customer service support. In some examples, the system may be used with a customer having an augmented reality device, such as an augmented reality device that may be incorporated into a wearable object such as a pair of glasses or other optical head-mounted display. In some arrangements, the customer may stream video of what is being viewed through the augmented reality device (e.g., a laptop screen, desktop screen, mobile device screen, or the like). The streamed video may be displayed on a computing device display of a customer service agent or associate. The customer service associate may then move a cursor over the display of the streamed image (e.g., move the cursor on the computing device display) to indicate one or more items of interest to the customer, instructions to the customer, or the like. The customer service associate's cursor movements on the computing device display may be replicated and reproduced on a display of the augmented reality device. Accordingly, as the customer is looking at the laptop screen, desktop screen, or the like (e.g., the image being streamed to the customer service associate), the cursor may appear on the augmented reality device display to indicate to the customer the items of interest, instructions, or the like.

For instance, the customer service associate may indicate a series of selections to be made by the user. The series of selections may be indicated by the cursor appearing on the augmented reality device display which aligns with or overlays the screen being viewed. Accordingly, the user may mimic the series of selections made by the customer service associate using a mouse connected to the device being viewed (e.g., the laptop, desktop, mobile device, or the like) in order to implement the instructions provided by the customer service associate. These and various other aspects will be discussed more fully below.

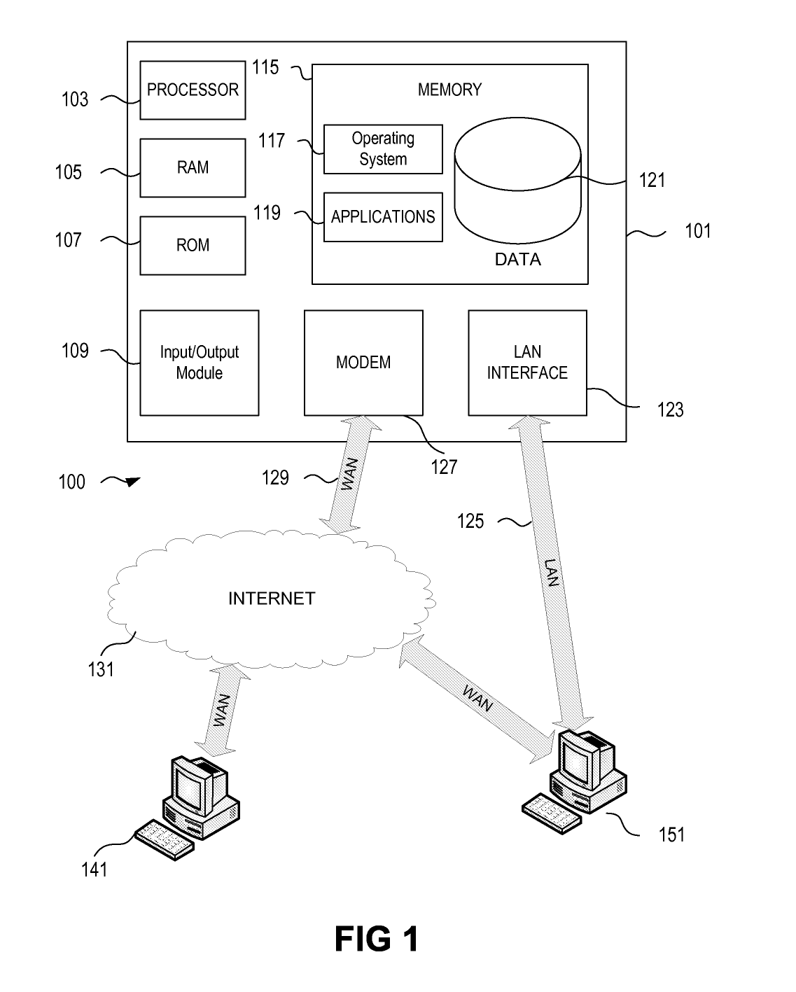

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

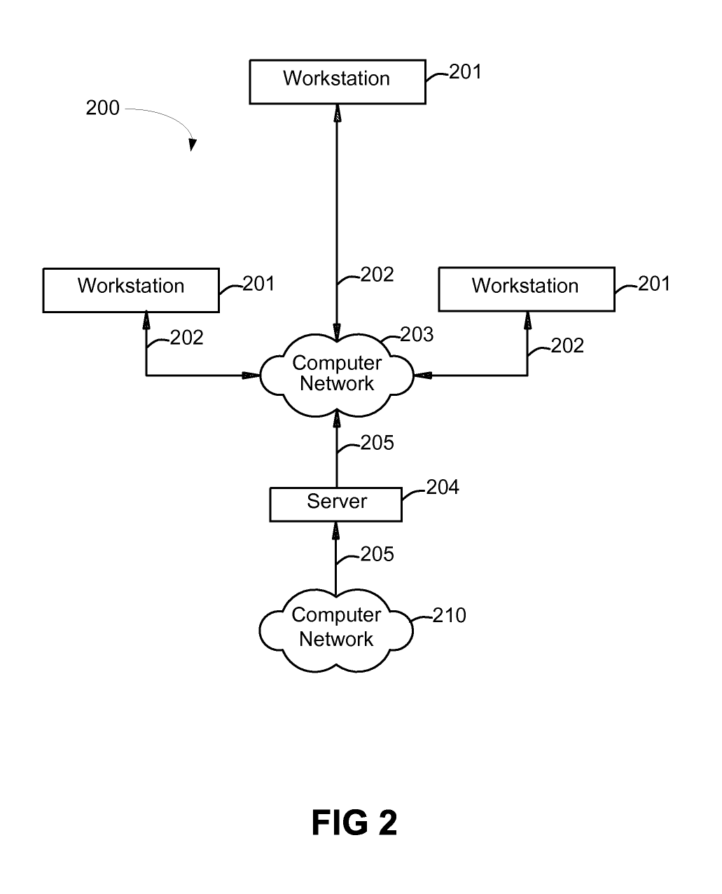

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

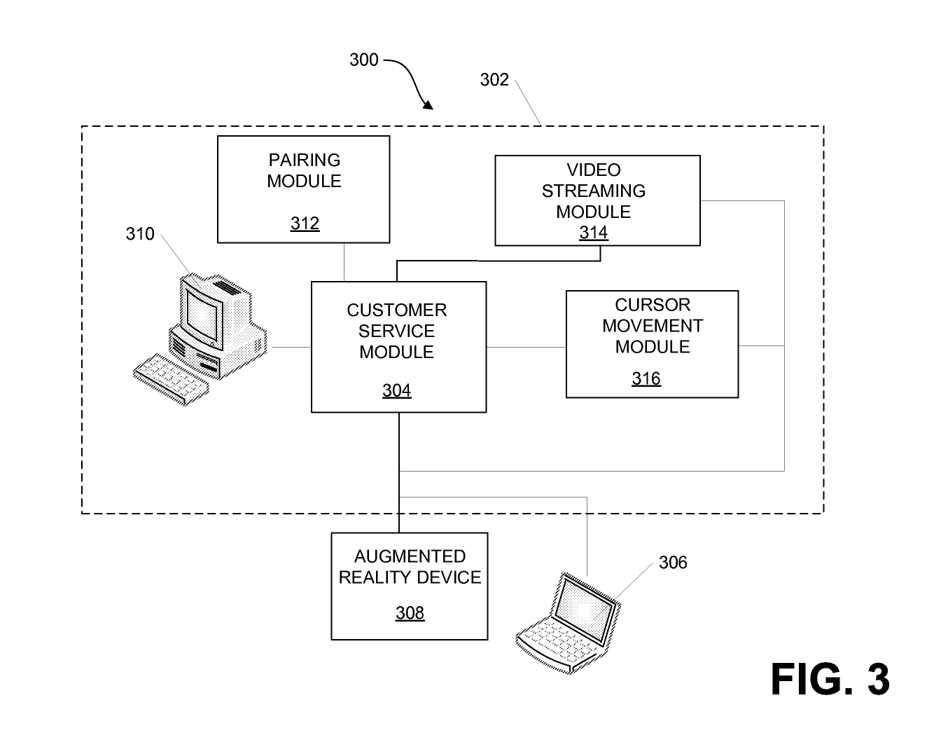

FIG. 3 illustrates one example two-way interactive customer service system 300 according to one or more aspects described herein. In some examples, the two-way interactive customer service system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the two-way interactive customer service system 300 to use within a financial institution. Rather, the system may be implemented by various other types of entities.

The two-way interactive customer service system 300 may include one or more modules that may include hardware and/or software configured to perform various functions within the system 300. In some examples, one or more modules within system 300 may be in physically separate devices. In other examples, one or more modules within system 300 may be formed in a single physical device or unit.

For instance, the two-way interactive customer service system 300 may include a customer service module 304. The customer service module 304 may receive a request for customer service from, for instance, a user, customer, or the like. Although the term “customer” may be used in various aspects of the description, any user or type of user may access the system. The term “customer” should not be viewed as limiting use of the system to only users with a pre-existing relationship with the entity but rather, any user or individual requesting customer service may use or access the system.

In some examples, the request for customer service may be made via an application, such as an online application or mobile application, on a customer or user computing device 306. For instance, a user may contact customer service via an online or mobile application on a laptop computing device (306 in FIG. 3), or any other type of computing device, such as a tablet computing device, desktop computing device, smart phone, or the like. The user or customer may then implement the use of the augmented reality device 308, which may also be in communication with the customer service module 304. In some examples, such as examples in which the augmented reality device is paired to an application or computing device of the user or customer, the request for customer service may be initiated via the augmented reality device.

Although the augmented reality device 308 is shown schematically in FIG. 3, the device may take various forms, including eye glasses or other optical, head-mounted displays, or other wearable devices. In some examples, the augmented reality device 308 may be a device overlaying the computing device 306 of the user or customer such that it can stream an image of the screen of the customer computing device 306 and may include a display for providing replicated cursor movements, as discussed herein.

The customer service module 304 may be connected to or in communication with one or more customer service associate computing devices, such as computing device 310. The associate computing device 310 is illustrated as a desktop type computing device. However, various other types of computing devices, such as laptop computing devices, tablet computing devices, and the like, may be used without departing from the invention. The customer service associate computing device 310 may be used to interactively communicate with a customer, such as via the augmented reality device 308, as will be discussed more fully herein.

The two-way interactive customer service system 300 may further include a pairing module 312. The pairing module 312 may include hardware and/or software configured to pair the augmented reality device 308 with the customer or user computing device 306, or an application associated with the customer computing device 306, such as a mobile or online banking application. In some examples, the pairing may be performed using Bluetooth technology. Once the pairing is performed, a user may be authenticated to the customer service system via the augmented reality device 308, as will be discussed more fully below.

The two-way interactive customer service system 300 may further include a video streaming module 314. The video streaming module 314 may be configured to transmit a request to the user of the augmented reality device 308 to request permission to stream images being viewed via the augmented reality device 308. For instance, the augmented reality device 308 may be equipped with a camera or other device configured to capture images, which, when the augmented reality device 308 is worn by a user, may capture images representative of what the customer or user is viewing. For instance, if the customer is viewing his or her computing device 306 through augmented reality glasses, the images viewed by the customer may be captured by a camera associated with the glasses. Accordingly, streaming these images to a customer service associate may aid in providing the customer service associate with accurate information regarding any issues the user or customer is having, questions regarding use of a system, and the like.

If permission to stream video is granted by the customer, video may be streamed from the augmented reality device 308 to the video streaming module 314. The images streamed may be displayed on a customer service associate computing device, such as device 310.

The two-way interactive customer service system 300 may further include a cursor movement module 316. The cursor movement module 316 may capture cursor movement or coordinates of cursor movement on the customer service associate computing device 310 and replicate those movements. The coordinates of the cursor movement may be transmitted to the augmented reality device 308 and replicated on a display of the augmented reality device 308. Accordingly, the customer or user may be able to view cursor movements made by the customer service associate on the customer service associate computing device 310 on the augmented reality device 308, without the customer service associate accessing the application or computing device 306 of the customer or user. That is, the cursor movements of the customer service associate are not displayed on the computing device of the customer or user 306. Rather, they are displayed on the display of the augmented reality device 308 such that they provide instruction to the customer or user. No action is taken by the replicated cursor movements (e.g., no selections made). Rather, the replicated cursor movements displayed on the augmented reality device 308 may be instructional in that they identify one or more features for the user, indicate where a user should click or options the user should select to rectify an issue, access features, or the like. The user may then manipulate a cursor associated with the customer computing device 306 by mimicking the replicated cursor movements on the customer computing device 306.

These and various other arrangements will be discussed more fully below.

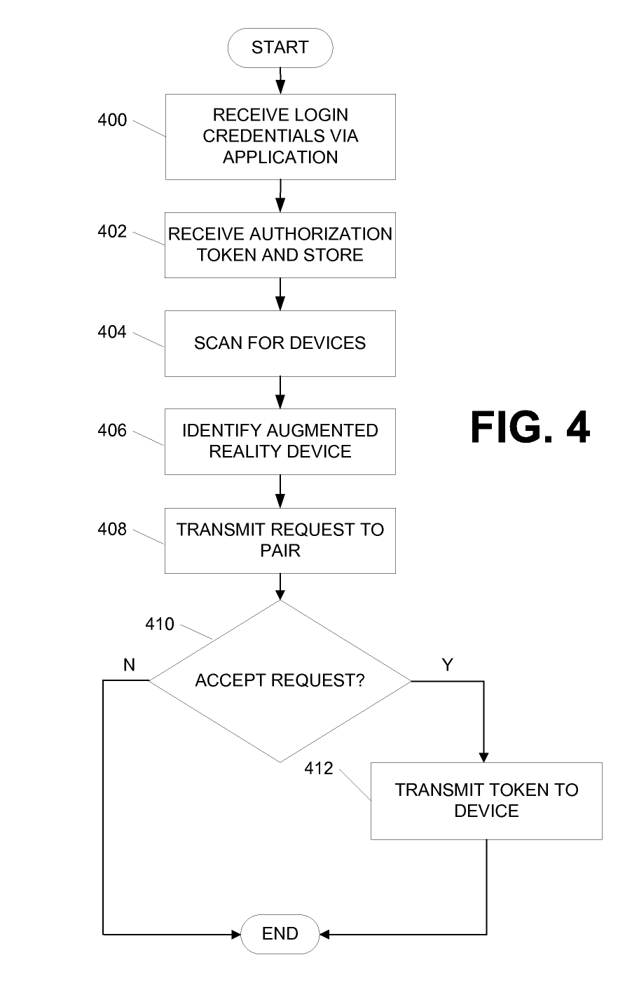

FIG. 4 illustrates one example method of associating or pairing an augmented reality device with a mobile device or application (e.g., an online or mobile application) according to one or more aspects described herein. The pairing process may be performed on an initial use of the augmented reality device with the two-way interactive customer service support system described herein and, once complete, the augmented reality device may be recognized, and a user authenticated, by the system without requiring additional authentication information, or the like.

In step 400, login credentials of a user are received via a mobile application or online banking application. For instance, a user may login to an application using a username and password, biometric data, or the like. In step 402, an authentication token, such as a soft authentication token, may be transmitted to and received by the device to which the user or customer has logged in. The token may be stored on the device.

In step 404, the device and/or application on the device may scan for one or more additional devices. For instance, the device and/or application may scan for one or more Bluetooth enabled devices. In step 406, the augmented reality device may be identified via the scan for Bluetooth enabled devices. In some arrangements, multiple devices of one or more types may be identified during the scan and a user may select a desired device (such as the augmented reality device) from a list of identified devices.

In step 408, a request to pair the identified device, e.g., the augmented reality device, with the application may be transmitted to the augmented reality device. The request may be displayed on a display of the augmented reality device and user input may be needed in order to accept the request. In some examples, accepting a request to pair the augmented reality device with the application may include receiving user input such as a tapping or selection of a button or other icon on the augmented reality device.

In step 410, a determination is made as to whether the request to pair the augmented reality device with the application has been accepted. If not, the process may end. If so, the token received in step 402 may be transmitted to the augmented reality device in step 412. The augmented reality device and a user or customer associated therewith may then be considered authenticated. The token may be stored by the augmented reality device and may be used for future authentication. That is, upon a user or customer opening the application or requesting customer service via the augmented reality device, the authentication token on the augmented reality device may provide authentication of the device without additional user input (e.g., input of login credentials, or the like).

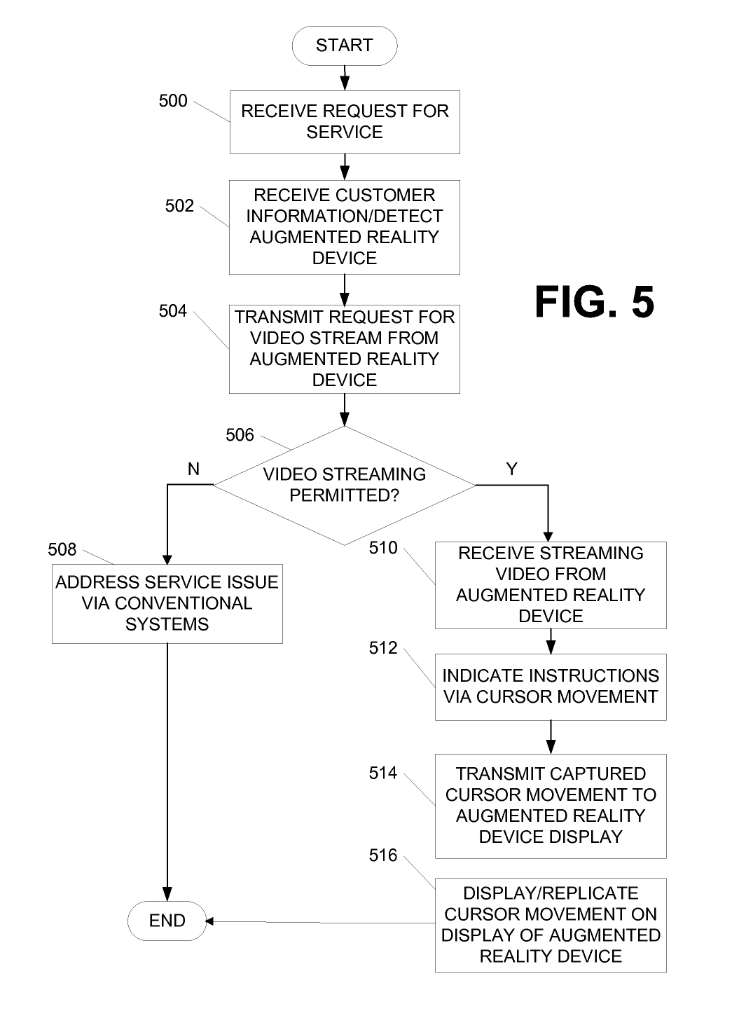

FIG. 5 illustrates one example method of receiving a request for customer service via the two-way interactive customer service system according to one or more aspects described herein. In step 500, a request for service is received. In some examples, the request for service may be received from a user or customer via an application, such as a mobile application or online application. Additionally or alternatively, the request for service may be received from an augmented reality device. In step 502, a customer service agent or associate acknowledges the request for service and customer or user information is forwarded to the customer service associate. For instance, information such as name, account type(s), amount of deposits, and the like, associated with the customer or user requesting service, may be provided to the customer service associate in order to facilitate servicing the user or customer. In some examples, the customer or user information provided to the customer service associate may include a user or customer profile associated with the user or customer requesting service.

Also, in step 502, in examples, in which the service request was initiated via a computing device or application associated with the computing device other than an augmented reality device, an augmented reality device associated with the user or customer may be detected or recognized. Accordingly, in step 504, a request to transmit streaming video from the augmented reality device to a computing device associated with the customer service associate may be transmitted to the user or customer. In step 506, a determination is made as to whether the customer or user has permitted video streaming. If not, in step 508, the customer service session may be conducted via conventional means, such as online or web chat, telephone call, or the like.

If, in step 506, the customer or user has permitted video streaming, an indication that streaming is permitted may be transmitted to the customer service associate computing device and, in step 510, streaming video may be received from the augmented reality device. The images received via streaming video may be displayed on the computing device of the customer service associate such that the associate is viewing the same or similar images to what the user or customer is viewing (e.g., via the augmented reality device). In some examples, the streaming video may include images of a computing device of the user (e.g., a laptop device, tablet computer, or the like). The computing device of the user or customer may include or display an application about which the user or customer is requesting service. Accordingly, the streaming video may permit the customer service associate to view the same or substantially the same images as the customer or user (e.g., the same website, web page, or the like).

In step 512, the customer service associate may move a cursor over the display of the streaming video in order to instruct the user or customer about various features, how to access one or more features, or the like. That is, in response to one or more inquiries made by the user or customer, the customer service associate may indicate, via cursor movements on the display of the streaming video on the computing device of the customer service associate, how the user or customer should proceed in order to address the inquiries of the customer or user. For instance, the customer service associate may indicate a selection to be made via the cursor, a series of selections to be made, or merely identify one or more features associated with the images being viewed by the user and the customer service associate.

In step 514, the cursor movements of the customer service associate may be captured and transmitted to a display of the augmented reality device. For instance, coordinates of the cursor movement(s) may be captured and transmitted to the augmented reality device. In step 516, the cursor movements may be replicated on the display of the augmented reality device based on the coordinates transmitted to the augmented reality device. Accordingly, as the user or customer is viewing the website, or the like, via the augmented reality device, the replicated cursor movements are shown on the display of the augmented reality device such that the user is able to view the cursor movements overlaying the application being viewed, in order to identify the selections or instructions provided by the customer service associate. The user may then perform the same or substantially similar cursor movements on the computing device of the customer or user in order to implement the instructions provided. Thus, although the customer service associate may indicate one or more selections to make, the display of the replicated cursor movements do not implement any of the selections. Rather, the user or customer may, independently of the customer service associate, make the provided or indicated selections via the computing device of the user or customer.

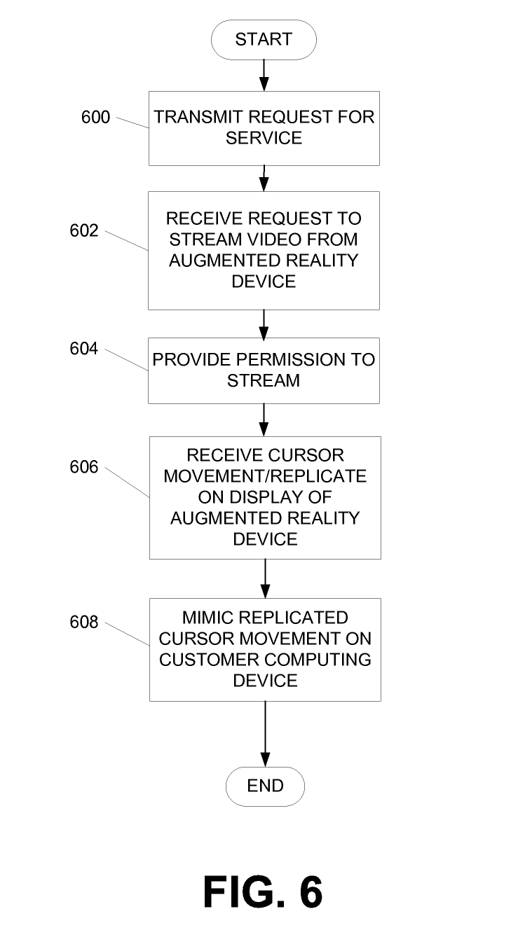

FIG. 6 illustrates one example method of requesting service via the two-way interactive customer service system according to one or more aspects described herein. In step 600, a request for service is transmitted to a system from, for example, a user or customer device. In some examples, the request may be transmitted from a computing device, such as a mobile device, laptop device, or the like. Additionally or alternatively, the request for service may be transmitted from an augmented reality device, such as augmented reality glasses.

In step 602, a request to stream video from the augmented reality device may be received by the augmented reality device. In step 604, permission to stream video from the augmented reality device may be transmitted to the system (e.g., by selecting an “OK” option, tapping the device or button on the device, or the like). The video being streamed may include images the same as or substantially similar to images or scenes being viewed by the user or customer. For instance, if the user is viewing an application on his or her computing device screen or display, the images of the computing device, screen and/or application may be streamed to the customer service associate to facilitate addressing the service request.

In step 606, coordinates associated with movement of a cursor on a computing device of a customer service associate (e.g., a cursor being manipulated by the customer service associate over the streamed images) may be received by the augmented reality device and replicated on the augmented reality device display. Accordingly, the cursor movements may be viewed by the customer or user in order to understand instructions being provided by the customer service associate. That is, the display of the augmented reality device may overlay the, in this example, computing device screen, and the cursor movements may then align with the application on the screen, thereby providing instructions to the user or customer.

In step 608, if desired, the user or customer may mimic the replicated cursor movements displayed on the augmented reality device in order to implement the instructions or suggestions provided by the customer service associate. The user or customer may elect to mimic all, some or none of the cursor movements indicated by the customer service associate or may choose to wait and implement the cursor movements at a later time.

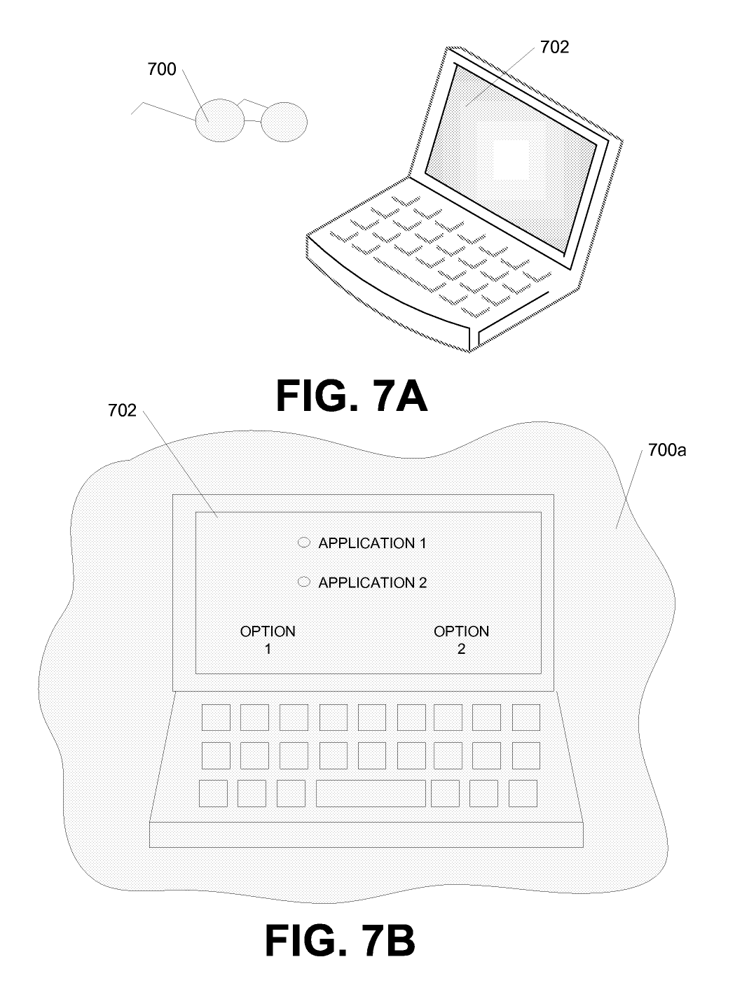

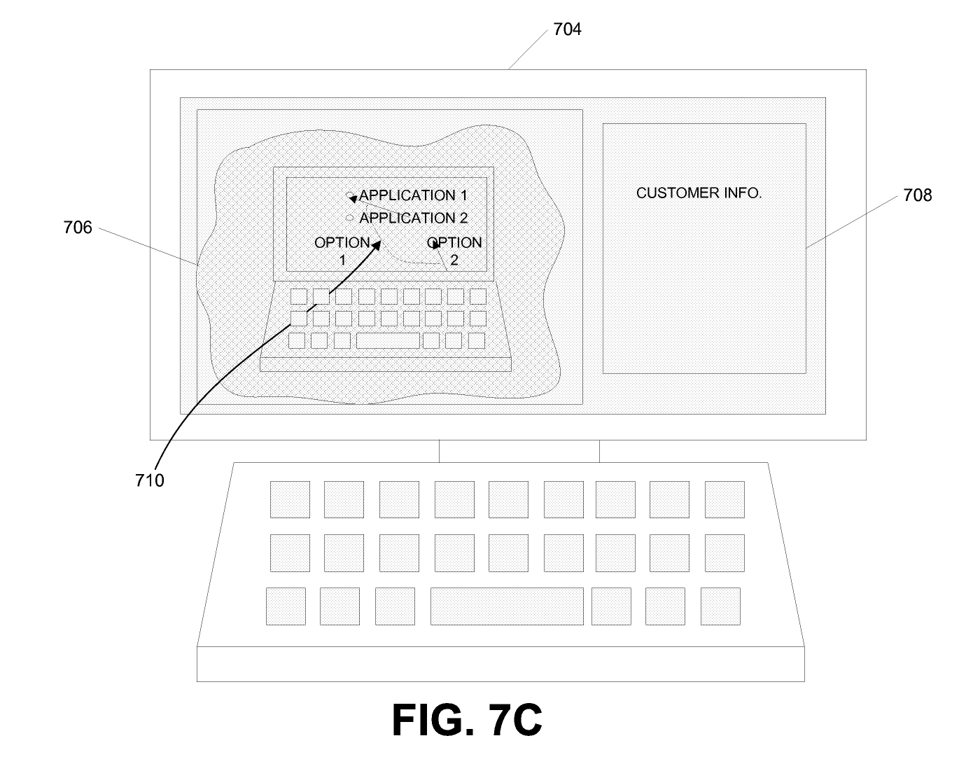

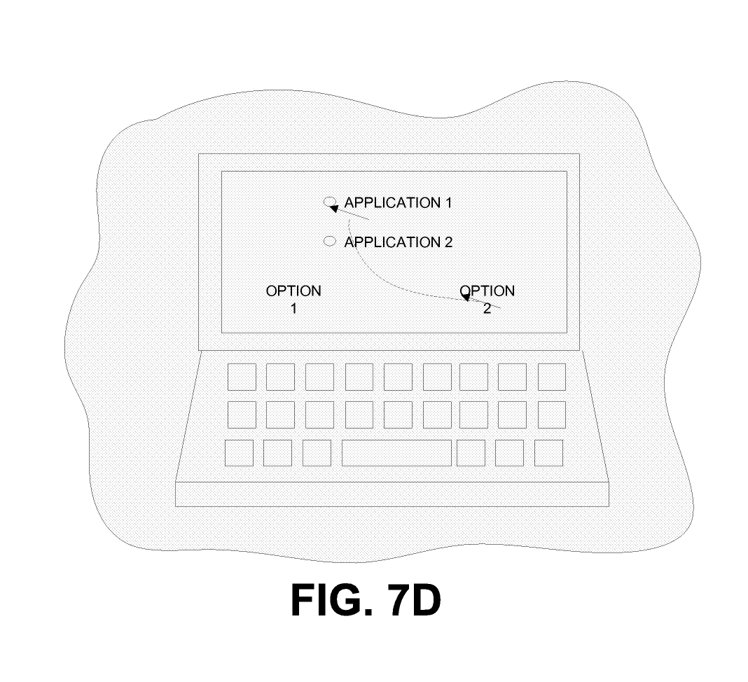

FIGS. 7A-7D illustrate various aspects of the two-way interactive customer service support system described herein. The images in FIGS. 7A-7D are merely schematic representations of some aspects of the systems, methods, and the like described herein and should not be viewed as limiting the disclosure to only the representations shown in FIGS. 7A-7D.

FIG. 7A illustrates a laptop computing device 702 of a user or customer, as well as an augmented reality device in the form of glasses 700. In some example uses of the arrangements described herein, the user or customer may view the laptop 702 through the augmented reality glasses 700.

FIG. 7B illustrates one example arrangement in which a user or customer is viewing the laptop 702 through the augmented reality glasses, as indicated by shaded region 700a. The screen on the laptop includes options for selecting different applications and options.

FIG. 7C illustrates one example customer service associate computing device 704. The computing device includes a display having region 706 which displays a video stream received from the augmented reality glasses 700. As shown in FIG. 7C, region 706 displays an image substantially similar to the image or scene viewed by the user or customer in FIG. 7B. The computing device 704 further includes customer information region 708 in which information associated with the customer (e.g., account information, contact information, or the like) may be displayed to the customer service associate.

FIG. 7C further includes a series of cursor movements indicated by element 710. The cursor movements may be performed by, for instance, a customer service associate, and may be used to indicate to the user or customer how to access features, resolve an issue, or the like. In the example shown in FIG. 7C, the customer service associate has indicated selection of “application 1” and “option 2” with the series of cursor movements.

Accordingly, in FIG. 7D, the cursor movements of the customer service associate are replicated on the display of the augmented reality glasses 700a. That is, the cursor movements are replicated on the display 700a of the augmented reality glasses that are viewing (e.g., overlaying) the laptop 702 screen. Thus, the user or customer can see the instructional cursor movements being provided by the customer service associate. However, in order to implement the instructional cursor movements, the user or customer may mimic the instructional cursor movements on the laptop 702 (e.g., via a mouse or other input device connected to the laptop 702).

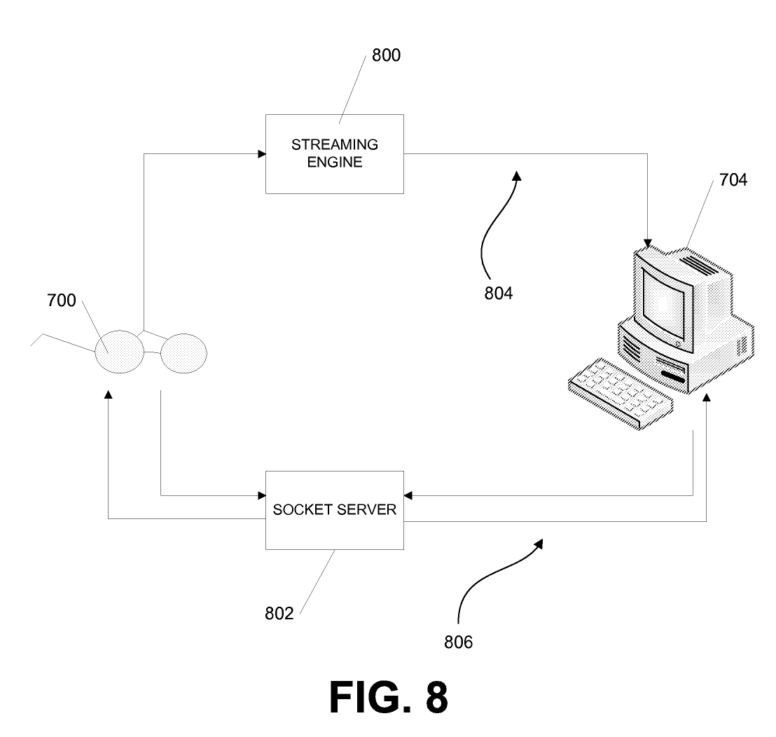

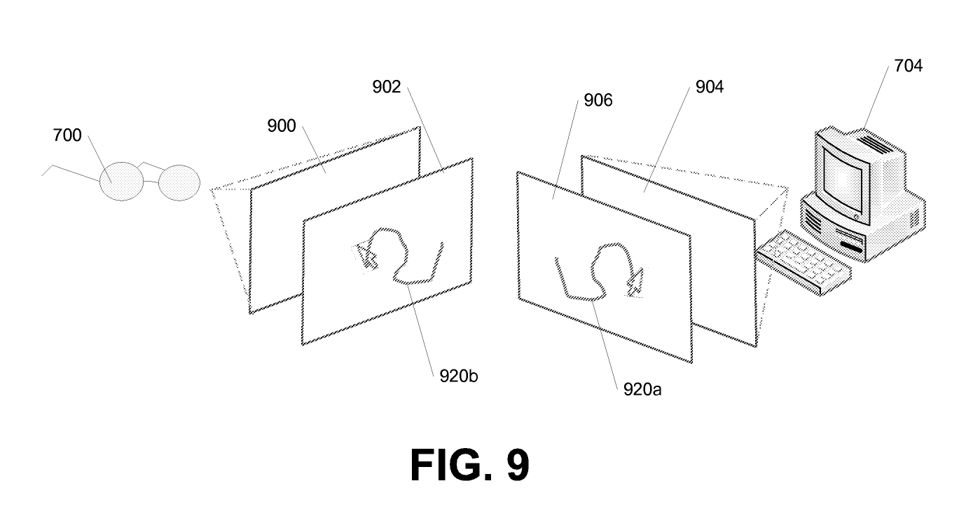

FIGS. 8 and 9 illustrate example systems and arrangements associated with the two-way interactive customer service supports systems, methods, and the like, discussed herein. The arrangements shown in FIGS. 8 and 9 are merely example arrangements and should not be viewed as limiting the disclosure to only those arrangements shown.

FIG. 8 illustrates one example system identifying communication links between an augmented reality device (such as glasses 700) and a customer service associate computing device (such as device 704). The system may include a streaming engine 800 configured to facilitate streaming of video from the augmented reality device 700 to the customer service associate computing device 704. In some arrangements, one or more additional applications may be used in order to facilitate streaming (e.g., a camera application configured to capture and stream images from the augmented reality device 700). The video may be streamed via communication stream 804, which may be a one-way communication stream.

In some examples, the video captured via the augmented reality device 700 may be a real time streaming protocol (RTSP) video stream. Accordingly, in some arrangements, the RTSP stream may be converted (e.g., via the streaming engine 800) to a real time messaging protocol (RTMP) stream, in order to facilitate viewing and/or capturing cursor movements on the customer service associate computing device 704.

In addition to the video stream communication link 804 between the augmented reality device 700 and the customer service associate computing device 704, a two-way data/messaging communication link 806 may also be provided. Communication via link 806 may be through a socket server 802 which may facilitate authentication of the augmented reality device 700, as discussed herein. Customer or user information transmitted to the customer service associate computing device 704 may also be transmitted via the socket server 802.

In some arrangements, one or more event flags may be transmitted via communication via link 806. The event flags may aid in tracking customer actions, customer service associate actions, and the like. For instance, each message carried between devices 700 and 704 may include an event flag. Accordingly, the message origin may be tracked. Some example events that may include an event flag may include start streaming, stop streaming, client disconnect, send mouse coordinates, receive mouse coordinates, new client connected, and the like.

FIG. 9 illustrates a schematic arrangement indicating various aspects of the two-way interactive communication system described herein. FIG. 9 illustrates an augmented reality device, such as augmented reality glasses 700. In some examples, the display of the augmented reality device 700 may include a canvas view 902 overlaying a surface view 900. The canvas view 902 may facilitate replication, animation, or the like, of cursor coordinates (corresponding to cursor movements) received from the customer service associate computing device 704. In some examples, a thread may run in the background to receive x and y coordinates of the cursor movements of the customer service associate. The cursor movement may then be replicated on the canvas view 902, as indicated by cursor movements 920b.

The customer service associate computing device 704 may include a first surface 904, configured to display streaming images, as described herein. The device 704 may further include settings which may permit a transparent hypertext markup language (HTML) layer to be overlaid on streaming or other video images. Further, the display may include a HTML overlay surface 906 which may be configured to capture the coordinates of cursor movement 920a overlaid on the video player (e.g., surface 904). The cursor movement coordinates may then be transmitted to the augmented reality device 700, as discussed herein.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive a request for customer service assistance;
receive, from an augmented reality device, a video stream of an image being viewed;
display, on a display of a computing device of a customer service associate, the video stream;
capture coordinates of a cursor movement over the displayed video stream on the computing device of the customer service associate; and
transmit, to the augmented reality device, the captured cursor coordinates for replication of the cursor movement on the augmented reality device.

2. The apparatus of claim 1, wherein the request for customer service assistance is received from the augmented reality device.

3. The apparatus of claim 1, further including instructions that, when executed, cause the apparatus to:
detect the augmented reality device; and
transmit a request to pair the augmented reality device with an application.

4. The apparatus of claim 1, further including instructions that, when executed, cause the apparatus to:
transmit, by the computing device of the customer service associate, a request to receive, the video stream from the augmented reality device.

5. The apparatus of claim 1, wherein the image being viewed includes an image of a computing device of a user associated with the augmented reality device.

6. The apparatus of claim 1, wherein the augmented reality device is a wearable device.

7. The apparatus of claim 1, wherein the augmented reality device includes augmented reality glasses.

8. An apparatus, comprising:
at least one processor; and
a memory storing computer-readable instructions that, when executed by the at least one processor, cause the apparatus to:
transmit a request for customer service assistance;
transmit a video stream from an augmented reality device to a computing device of a customer service associate;
display, by the computing device of the customer service associate, the transmitted video stream;
receive, by the augmented reality device, coordinates associated with movement of a cursor on the display of the video stream on the computing device of the customer service associate; and
display, on a display of the augmented reality device, replicated cursor movement based on the received coordinates.

9. The apparatus of claim 8, wherein the request for customer service assistance is transmitted by the augmented reality device.

10. The apparatus of claim 8, further including instructions that, when executed, cause the apparatus to:
receive, from the computing device of the customer service associate, a request to transmit the video stream from the augmented reality device to the computing device of the customer service associate; and
receive, by the augmented reality device, user input permitting transmission of the video stream.

11. The apparatus of claim 8, wherein the video stream includes an image of a computing device of a user associated with the augmented reality device

12. The apparatus of claim 8, wherein the augmented reality device is a wearable device.

13. The apparatus of claim 8, wherein the augmented reality device includes augmented reality glasses.

14. A method, comprising:
receiving, by a computing device of a customer service associate and from an augmented reality device, a video stream of an image being viewed;
displaying, by a display of the computing device of the customer service associate, the video stream;
capturing, by the computing device of the customer service associate, coordinates of a cursor movement over the displayed video stream on the computing device of the customer service associate; and
transmitting, to the augmented reality device, the captured cursor coordinates for replication of the cursor movement on a display of the augmented reality device.

15. The method of claim 14, further including receiving, by the augmented reality device, a request for customer service assistance.

16. The method of claim 14, further including:
detecting the augmented reality device; and
transmitting a request to pair the augmented reality device with an application.

17. The method of claim 14, further including:
transmitting, by the computing device of the customer service associate, a request to receive the video stream from the augmented reality device.

18. The method of claim 14, wherein the image being viewed includes an image of a computing device of a user associated with the augmented reality device.

19. The method of claim 14, wherein the augmented reality device is a wearable device.

20. The method of claim 14, wherein the augmented reality device includes augmented reality glasses.
